(19) United States
(12) Patent Application Publication
(10) Pub. No.: US 2022/0138694 A1
(43) Pub. Date: May 5, 2022

(54) SYSTEM AND METHOD FOR PROJECT MANAGEMENT

(71) Applicant: Gannett Fleming, Inc., Camp Hill, PA (US)

(72) Inventors: Brett A. BRENIZE, Mechanicsburg, PA (US); Carmen M. FIGUEROA, Norfolk, VA (US); Benjamin K. CHRISTENSEN, Camp Hill, PA (US); Robert S. HARRISON, Camp Hill, PA (US)

(21) Appl. No.: 17/226,373

(22) Filed: Apr. 9, 2021

Related U.S. Application Data
(60) Provisional application No. 63/107,079, filed on Oct. 29, 2020.

(51) Int. Cl. G06Q 10/10; G10L 15/26; G10L 15/22; G06Q 50/08

(52) U.S. Cl. CPC G06Q 10/103; G06Q 50/08; G10L 15/22; G10L 15/26

(57) ABSTRACT

A collaborative information virtual assistant and a project management system which provides seamless data management, information retrieval and project forecasts to assist with project management in the architecture, engineering, and construction industries, the system includes a job-site specific virtual assistant that uses voice technology to help facilitate project workflows.

### FIELD OF THE INVENTION

The present invention is directed to a system and method for managing projects. In particular, the invention is directed to a system and method that provides seamless data management, information retrieval, and project forecasts for the architecture, engineering and construction industry.

### BACKGROUND OF THE INVENTION

Condition assessments and inspections are a critical step in determining the safety, viability and integrity of infrastructure and other building systems. Developing an accurate and thorough condition assessment report helps owners address maintenance needs, deficiencies, and costs of preserving their infrastructure. For example, 23 CFR 650 is the federal regulation that established the Nation Bridge Inspection Standards. This regulation, supervised by the FHWA, requires state DOT's to follow the strict protocols that require regular bridge assessments. Additionally, there are similar inspection regulations for our nation's tunnels, transit systems, water, wastewater and power.

Condition assessment and inspection of infrastructure and other building systems is extremely important. This requires data to be collected in the field, allowing reports to be developed and evaluations to be completed to determine the level of repairs, rehabilitation, and replacement that is necessary to keep our infrastructure safe and operational. While owners have invested in software to help them manage infrastructure, their field data collection is most often done by taking notes to be compiled into a report days later. Consequently, the collection of data and the generation of reports is often inefficient and lacking, as the data collection is often incomplete and the reports can not be generated in real time.

It would, therefore, be beneficial to a develop a system and method for managing projects which overcome the deficiencies of the known art. In particular, it would be beneficial to provide a system and method for managing projects that provide real time, seamless data management, information retrieval, and project forecasts for the architecture, engineering and construction industry.

### SUMMARY OF THE INVENTION

An object is to overcome industry challenges by offering a product that provides seamless access to program data and better access to data in the field.

An object is to incorporate increased awareness of safety concerns by predictive analysis.

An object is to enhance document management capabilities and efficiency in document development and record retrieval.

An object is to leverage voice collected information from various sources and produce accurate data and actionable insights, to provide a personalized, targeted, and frictionless experience for each client/user.

An object is to provide a collaborative information virtual assistant and system for the architecture, engineering and construction (AEC) industry for integrating data between systems, with voice recognition technology. The a collaborative information virtual assistant and system utilizes voice recognition technology as an integration platform for mobile field personnel.

The invention is directed to a collaborative information virtual assistant and system for the architecture, engineering and construction industry. This system uses ear buds that allow a field inspector, for example, to capture every element of a report simply by speaking out loud. It does not require the handheld use of a mobile phone or tablet which enables the worker to be fully cognizant of their surroundings. Unlike traditional headphones the ear buds are equipped with “Pass-Through Audio” meaning that you can hear everything that is going on around you while making reports, tracking deliveries, managing on site assets, or even talking on the phone.

The invention is directed to a collaborative information virtual assistant and system that captures all the information and data and compiles the information and data into an automatically generated report that is tailored to the specific architecture, engineering or construction project. The compiled information and data is stored in the cloud for on-demand access.

Leveraging voice technology in the construction industry allows for the capture of a high fidelity of project data while keeping the worker safe and fully aware of the environment around them. Project data recorded through the collaborative information virtual assistant and system is also tagged with a geo-location marker that instantly populates on a dashboard to allow a user to monitor the job in real-time and see exactly what information was captured and precisely when and where it was logged.

The collaborative information virtual assistant and system of the present invention can record project data accurately and access that information anytime it is needed. The assistant and system also allows field staff the ability to work independently of a mobile phone or tablet so that they can remain focused solely on the task at hand. The assistant and system also reduces the likelihood of rework related to data loss by maintaining project data in a central repository.

An embodiment is directed to a project management system for managing a project in the architecture, engineering and construction industries. The project management system include a remote database and a collaborative information virtual assistant. The remote database is physically removed from the project. The collaborative information virtual assistant has a voice enabled device and a web component. The voice enabled device enables voice recognition technology to be an integration platform for mobile field personnel. The web component generates a field survey, receives results from the field survey, authenticates the mobile field personnel and forwards the results from the field survey via webhooks to the remote database. The project management system allows for the capture of data for the project in the architecture, engineering and construction industries while allowing the mobile field personnel to be fully cognizant of their surroundings.

An embodiment is directed to a project management system for managing a project in the architecture, engineering and construction industries. The project management system include a remote database, a collaborative information virtual assistant and a geospatial detection device. The remote database is physically removed from the project. The collaborative information virtual assistant has a voice enabled device and a web component. The web component generates a field survey, receives results from the field survey, authenticates the mobile field personnel and forwards the results from the field survey via webhooks to the remote database. The voice enabled device enables voice recognition technology to ask mobile field personnel questions from the field survey and record the mobile field personnel verbal answers. The geospatial detection device provides a geo-location marker. The project management system allows for the capture of data and the marking of the data with the geo-location marker for the project in the architecture, engineering and construction industries while allowing the mobile field personnel to be fully cognizant of their surroundings.

An embodiment is directed to a collaborative information virtual assistant for managing projects in the architecture, engineering and construction industries. The collaborative information virtual assistant includes a web component for generating a field survey, receiving results from the field survey, authenticating the mobile field personnel and forwarding the results from the field survey via webhooks to a remote database in real time. A voice enabled device is provided. The voice enabled device enables voice recognition technology to ask mobile field personnel questions from the field survey and record the mobile field personnel verbal answers. A geospatial detection device is also provided for generating a geo-location marker. The project management system allows for the capture of data and the marking of the data with the geo-location marker for the project in the architecture, engineering and construction industries in real time while allowing the mobile field personnel to be fully cognizant of their surroundings.

Other features and advantages of the present invention will be apparent from the following more detailed description of the illustrative embodiment, taken in conjunction with the accompanying drawings which illustrate, by way of example, the principles of the invention.

### BRIEF DESCRIPTION OF THE DRAWINGS

FIG. 1. Is a block diagram of an illustrative embodiment of the architecture of the system and method.

FIG. 2 is a block diagram of an illustrative embodiment of the workflow of the invention.

FIG. 3 is a block diagram of an illustrative embodiment of the workflow of the invention.

FIG. 4 is a block diagram of an illustrative embodiment of the workflow of the invention.

FIG. 5 is a flow chart of an illustrative embodiment of the workflow of the invention.

The information provided in the drawings is hereby incorporated by reference in its entirety.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

In general, users will install a voice recognition app on their mobile device and will then install the collaborative information virtual assistant. Once the user has successfully installed the collaborative information virtual assistant, the user will have the ability to voice activate the collaborative information virtual assistant and provide the collaborative information virtual assistant with a set of voice commands that address the use cases developed as part of the system product set.

As part of the collaborative information virtual assistant installation process, users will be prompted for their username and password for a third party software product, providing the collaborative information virtual assistant with direct access to their data from the third party software product. Alternatively, users will create a collaborative information virtual assistant account with a set of system-specific credentials, and will then connect to a third party software product with credentials specific to that product. This will allow for a single sign-on.

The collaborative information virtual assistant and system of the present invention integrates data between systems, with voice. Among the many advantages of the collaborative information virtual assistant and system, the collaborative information virtual assistant and system leverages trends in consumer technologies and re-factors them into a tool for the mobile workforce. The architecture of the collaborative information virtual assistant and system treats voice as an integration platform for mobile field personnel.

The method or system 12 provides seamless data management, information retrieval and project forecasts to assist with project management in the architecture, engineering, and construction industries (AEC). It includes a job-site specific virtual assistant 10 that uses voice technology to help facilitate project workflows. The system 12 automatically collects data for field reports, conditions assessments, project closeouts, asset capture and more.

The collaborative information virtual assistant 10 has two architectural components. The first is a field survey 14, which captures answers from users to field survey questions using a microphone enabled device 16 and a cloud-based voice service 18. The collaborative information virtual assistant 10 presents questions to the user, captures their answers with their voice enabled microphone or other voice capture device and processes the answers with a cloud-based web service.

The collaborative information virtual assistant 10 can ask specific questions regarding the inspection which will standardize the format of data collection as well as verify that critical elements are not overlooked. The collaborative information virtual assistant 10 and the field survey 14 can be easily tailored to a specific owner's assessment. Additionally, photos can be uploaded, comments can be added by voice, and general notes can be dictated directly into the collaborative information virtual assistant 10. All of this can be done with both hands free thus significantly increasing the safety of the inspector.

In many embodiments, the collaborative information virtual assistant 10 has a geospatial detection device which associates geolocation tags with the data collected. This allows the data to be stored and retrieved based on location for future assessments.

Once all the questions have been answered and validated, the collaborative information virtual assistant 10 bundles the questions together and sends them to integrated systems using the second architectural component: collaborative information virtual assistant and system webhooks 22. The collaborative information virtual assistant and system webhooks 22 send conditionally triggered automated messages from the collaborative information virtual assistant 10 to one or more other software packages 24, examples of which are shown in the figures. They have a message, or payload, and are sent to a unique URL address. The collaborative information virtual assistant and system webhooks 22 act as gatekeepers for the collaborative information virtual assistant and system. The collaborative information virtual assistant and system webhooks 22 accept results from the collaborative information virtual assistant field survey 14 and determine where the results should be sent based on the user, project, location and/or data in the survey results.

By separating the data collection and data integration components, the collaborative information virtual assistant 10 and system 12 remain flexible, with options for deployment into nearly every third party software package used by a customer. The collaborative information virtual assistant 10 and system 12 are also stable and carry no dependencies between systems. This means that one software package can change without affecting the others.

The collaborative information virtual assistant 10 has a system web component 24 which is responsible for creating user accounts, adding surveys, configuring webhooks, and forwarding survey results to the webhooks 22. The collaborative information virtual assistant 10 includes a custom voice recognition skill 26 that is used to present survey questions to the user and capture their answers. The third component are the actions 27.

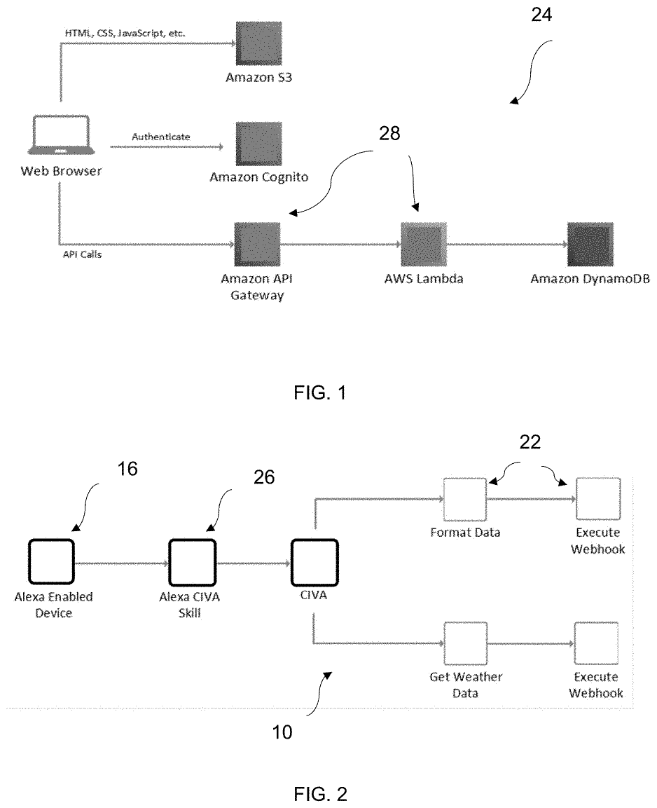

As shown in the illustrative architecture shown in FIG. 1, the system web component 24 of the collaborative information virtual assistant 10 application architecture incorporates and uses known software products and methods, including, but not limited to, an event-driven, serverless computing platform, an API Gateway, object storage through a web service interface, a database service that supports key-value and document data structures, a user identity and data synchronization service, and a development platform for building secure, scalable mobile and web applications. The system web component 24 is responsible for user accounts, configuring surveys, and processing survey results. It is comprised of an Angular web application and multiple AWS services on the backend.

Development platforms 28 host static web resources including HTML, CSS, JavaScript, and image files which are loaded in the user's browser via object storage interface. JavaScript, or other language, executed in the browser sends and receives data from a public backend API which as built using programs such, Lambda and API Gateway. User identity and data synchronization services provide user management and authentication functions to secure the backend API. Finally, database services with documentation data structures, provide a persistence layer where data can be stored by the API's Lambda functions. AWS Amplify, an open source project that is used to help get speed the development of AWS hosted projects, may be used as the development platform. However, other development platforms may be used.

In various embodiments, the application architecture of the system web component 24 may use, but is not limited to, AWS Lambda, Amazon API Gateway, Amazon S3, Amazon DynamoDB, Amazon Cognito, Amazon Simple Queue Service (SQS), and Amazon Simple Notification Service (SNS).

In these illustrative embodiments, Amazon S3 hosts the static web resources including HTML, CSS, JavaScript, and image files which are loaded in the user's browser via S3. JavaScript executed in the browser sends and receives data from the backend API built using Lambda and API Gateway. Amazon Cognito provides user management and authentication functions to secure the backend API. DynamoDB provides a persistence layer where data can be stored by the API's Lambda functions. Amazon SQS and SNS are used to process configured actions.

The second component, the custom voice recognition skill is used to present survey questions to the user and capture their answers. Once the survey is completed, the results are passed to the system web component 24 to process the results.

The third component, the actions 27, are used to process the results of saved surveys. Actions 27 can be chained together to form complex workflows based on rules and conditions. Some examples would be to calculate the next inspection date based on the current date, create features, update a spreadsheet, send email or text notifications.

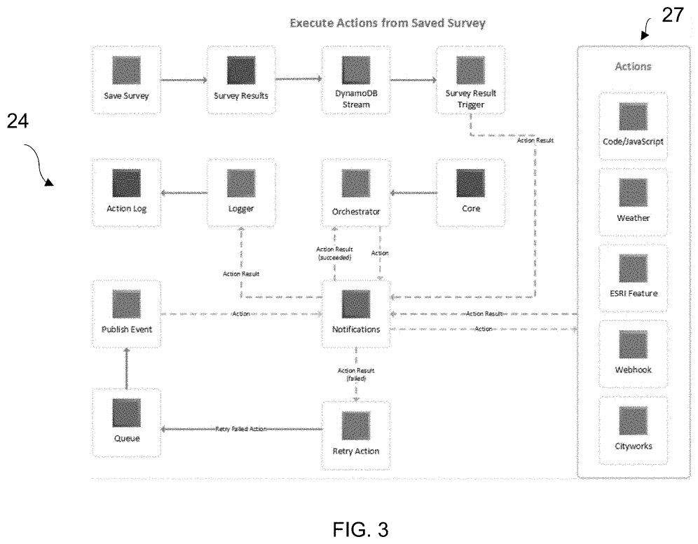

As shown in the illustrative workflow shown in FIGS. 2 and 3, the collaborative information virtual assistant 10 workflow uses an a voice enabled device 16, an app that lets you launch a skill through voice commands 26, the collaborative information virtual assistant 10 application, and a program that integrates or moves information between applications (such as webhook). The voice enabled device 16 is used to present a list of questions to the user and capture their answers. The voice app or skill 26 is used to send the list of questions to the device and process the answers. Once all the questions have been answered and validated, the collaborative information virtual assistant 10 will bundle the questions together and send them to the webhooks 22. The collaborative information virtual assistant 10 is used as a gatekeeper. It accepts results from the voice app and determines where the results should be sent based on the user who submitted the answers. The program that moves integrates information is used to consume the results. It is highly configurable and can do many things like saving the results to Excel, sending emails, and forwarding the results to third party APIs.

FIG. 3 is a diagram which illustrates the steps that occur within collaborative information virtual assistant 10. The data flows from the custom voice recognition skill 26, processed in the system web component 24 and distributed to various actions 27.

In the illustrative embodiment shown, the system web component 24, which is an AWS Lambda function, creates a JSON object containing the questions and answers and saves them to a DynamoDB table along with the survey ID, Name and the user who completed the survey. The DynamoDB streams the survey results to another Lambda function. This function will publish a survey created event to SNS. The Orchestrator function captures the event and determines what actions are defined for the survey. The Orchestrator will publish action events as needed. Each action is configured to listen for events that are responsible for processing. Once the action completes or fails, it publishes a completed event. The Orchestrator will listen for action events that complete successfully and will determine if another action should be executed.

Failed actions will go throw the retry workflow where the SQS que will hold the action event until the time delay has expired. Once expired the que will send it back to the action for processing. This process will repeat up to 10 times.

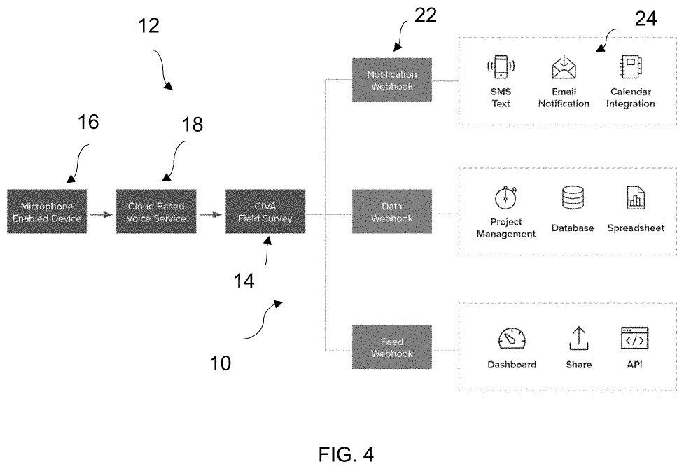

As shown in FIG. 4, the system presents questions to the user, captures their answers with their voice enabled microphone and processes the answers with a cloud-based web service. Once all the questions have been answered and validated, the system will bundle the questions together and send them to integrated programs using the second primary component, one of the system webhooks. The system has three primary webhooks, which include notification, data, and feed webhooks. Each of the webhooks act as a gatekeeper in the system. The webhooks accept results from the system field survey and determine where the results should be sent based on the user, project, and data in the survey results.

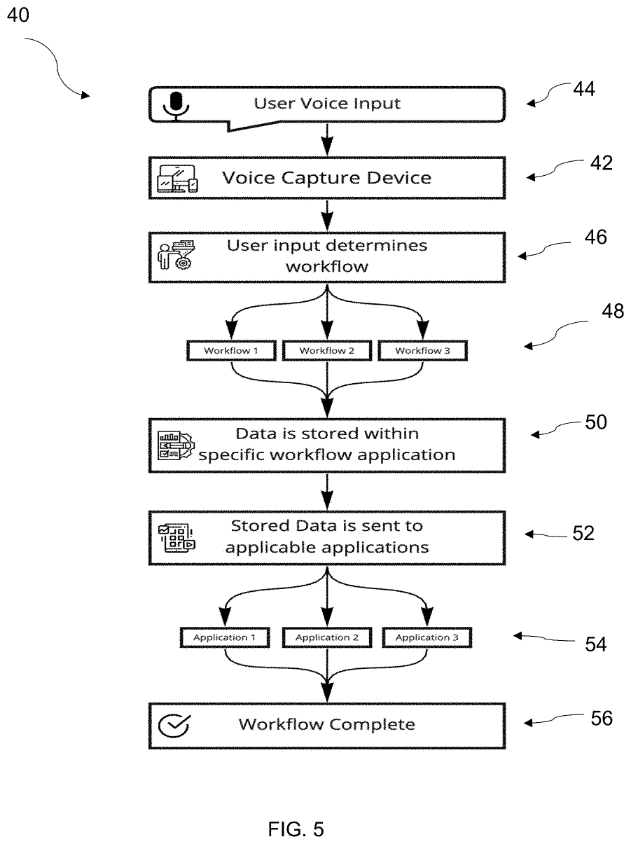

As represented by FIG. 5, the system operational workflow 40 is user initiated with the use of voice assistant software loaded onto a user device, as represented by 42 such as, but not limited to, a mobile device. The system captures commands from users using a microphone enabled device and a cloud-based voice service. The user then answers, in a conversational format, a series of questions generated by the system, as represented by 44. Once all the questions have been answered and validated, the system will use the input to bundle the answers together and determine workflow, as represented in 46. The workflow, as represented by 48, is stored with specific workflow applications, as represented by 50. The stored data is then sent to applicable applications as needed or required, as represented by 52, 54 to complete the workflow, as represented by 56.

The system 12 provides seamless data management, information retrieval, and project forecasts. The system increases project safety and allows for complete collaboration across all aspects of a program or project in the fields of architecture, engineering, and construction. From conception and design development, during construction, and throughout the entire life of the completed project or facility, the system will provide a seamless transition as the owner's program or project is developed and make informed recommendations throughout the entire program lifecycle. As the system “learns” more and more about the types of projects or facilities for a given owner, the system will make informed decisions, assisting with efficiency, improvements in design, construction methods, and maintenance and operations considerations.

As construction progresses the system can “learn” the actual production capacity of specific crew types and help analyze recovery and acceleration options. Once the project is complete the system can be switched to a maintenance and operations mode and become a maintenance and operations virtual assistant. As the system's maintenance and operations virtual assistant is used over time and “learns” the facility's maintenance and operational needs, the maintenance and operations virtual assistant will anticipate asset requirements that improve efficiency and provide life cycle cost reduction. As multiple projects are linked in system and the maintenance and operations virtual assistant of the system, they become a program management tool which adapts to the changing environment and needs.

The system is beneficial in many applications, including, but not limited to, large complex projects which require the management of diverse assets across great distances. The potential to use the collaborative information virtual assistant 10 and system on major transportation projects to participate in development of this technology also exists. Users include, but are not limited to government entities and clients and facilities clients with numerous resources such as large pharmaceutical companies, universities, etc.

The collaborative information virtual assistant 10 and system provides infrastructure owners the power to inspect, analyze and manage the condition of their infrastructure. The information spoken into collaborative information virtual assistant 10 is immediately stored in a retrievable database and can populate a report format in real-time. With this data collection system 12 an engineer developing a condition assessment report can work virtually with an on-site inspector and create a report in real-time using the collaborative information virtual assistant 10. The collaborative information virtual assistant 10 and system 12 will greatly enhance project reporting and operations with the use of dashboards, report automations, location mapping, voice technology, and notification systems.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A project management system for managing a project in the architecture, engineering and construction industries, the project management system comprising:
a remote database, the remote database being physically removed from the project;
a collaborative information virtual assistant comprising;
a voice enabled device, the voice enabled device enabling voice recognition technology to be an integration platform for mobile field personnel;
a web component for generating a field survey, receiving results from the field survey, authenticating the mobile field personnel and forwarding the results from the field survey via webhooks to the remote database;
wherein the project management system allows for the capture of data for the project in the architecture, engineering and construction industries while allowing the mobile field personnel to be fully cognizant of their surroundings.

2. The project management system as recited in claim 1, wherein the collaborative information virtual assistant has a geospatial detection device which associates geolocation tags with the results from the field survey and other data collected.

3. The project management system as recited in claim 1, wherein the webhooks send conditionally triggered automated messages from the collaborative information virtual assistant to one or other software packages.

4. The project management system as recited in claim 3, wherein the webhooks act as gatekeepers for the collaborative information virtual assistant.

5. The project management system as recited in claim 1, wherein the system web component uses an event-driven, serverless computing platform.

6. The project management system as recited in claim 1, wherein the communication between the collaborative information virtual assistant and the remote database is done in real time.

7. The project management system as recited in claim 1, wherein the collaborative information virtual assistant includes actions, which are used to process results of saved surveys in the remote database, the actions can be chained together to form complex workflows based on rules and conditions.

8. The project management system as recited in claim 1, wherein upon answering and validating all the questions in the field survey, the web component bundles the answers together and sends them to other integrated programs through the webhooks.

9. The project management system as recited in claim 1, wherein the voice enabled device has a microphone and a cloud-based voice service.

10. The project management system as recited in claim 1, wherein the webhooks include a notification webhook, a data webhook, and a feed webhook.

11. The project management system as recited in claim 1, wherein the collaborative information virtual assistant is initiated by a voice of the mobile field personnel.

12. The project management system as recited in claim 1, wherein from conception and design development, during construction, and throughout the entire life of a project, the project management system will learn from the data and make informed recommendations, wherein the project management system assists with efficiency, improvements in design, construction methods, and maintenance and operations considerations.

13. A project management system for managing a project in the architecture, engineering and construction industries, the project management system comprising:
a remote database, the remote database being physically removed from the project;
a collaborative information virtual assistant comprising;
a web component for generating a field survey, receiving results from the field survey, authenticating the mobile field personnel and forwarding the results from the field survey via webhooks to the remote database;
a voice enabled device, the voice enabled device enabling voice recognition technology to ask mobile field personnel questions from the field survey and record the mobile field personnel verbal answers;
a geospatial detection device for providing a geo-location marker;
wherein the project management system allows for the capture of data and the marking of the data with the geo-location marker for the project in the architecture, engineering and construction industries while allowing the mobile field personnel to be fully cognizant of their surroundings.

14. The project management system as recited in claim 13, wherein the webhooks act as gatekeepers for the collaborative information virtual assistant and send conditionally triggered automated messages from the collaborative information virtual assistant to one or other software packages.

15. The project management system as recited in claim 14, wherein the communication between the collaborative information virtual assistant and the remote database is done in real time.

16. The project management system as recited in claim 15, wherein the collaborative information virtual assistant includes actions, which are used to process results of saved surveys in the remote database, the actions can be chained together to form complex workflows based on rules and conditions.

17. The project management system as recited in claim 15, wherein upon answering and validating all the questions in the field survey, the web component bundles the answers together and sends them to other integrated programs through the webhooks.

18. The project management system as recited in claim 17, wherein the voice enabled device has a microphone and a cloud-based voice service.

19. The project management system as recited in claim 18, wherein the webhooks include a notification webhook, a data webhook, and a feed webhook.

20. A collaborative information virtual assistant for managing projects in the architecture, engineering and construction industries, the collaborative information virtual assistant comprising:
a web component for generating a field survey, receiving results from the field survey, authenticating the mobile field personnel and forwarding the results from the field survey via webhooks to a remote database in real time;
a voice enabled device, the voice enabled device enabling voice recognition technology to ask mobile field personnel questions from the field survey and record the mobile field personnel verbal answers;
a geospatial detection device for providing a geo-location marker;
wherein the project management system allows for the capture of data and the marking of the data with the geo-location marker for the project in the architecture, engineering and construction industries in real time while allowing the mobile field personnel to be fully cognizant of their surroundings.
